(19) United States
(12) Patent Application Publication
(10) Pub. No.: US 2018/0158145 A1
(43) Pub. Date: Jun. 7, 2018

(54) RESOURCE PLANNING SYSTEM, PARTICULARLY FOR VEHICLE FLEET MANAGEMENT

(71) Applicant: AssetWorks LLC, Wayne, PA (US)

(72) Inventors: David Mark Weigel, Villanova, PA (US); Marc Knight, Parkesburg, PA (US)

(21) Appl. No.: 15/366,718

(22) Filed: Dec. 1, 2016

(51) Int. Cl. G06Q 40/06

(52) U.S. Cl. CPC G06Q 40/06

(57) ABSTRACT

A system for physical asset resource planning including a capital asset management (CAM) application server in data communication with a CAM report server and a CAM database server; the CAM application server is configured to: execute a life cycle module for generating an asset life cycle model based on user inputs customizing the model for each instance of its execution and to execute a life cycle calculator for generating an annual cost for an asset based on the life cycle model and on a dataset received from the CAM database server. A CAM report server is configured to: execute a presentation module for displaying results of the life cycle module and the life cycle calculator to a user. A CAM database server stores a plurality of datasets related to the assets and provides data to the CAM application and report servers.

### TECHNICAL FIELD

The invention relates generally to resource and physical asset management, and more particularly to life cycle and capital expense management systems, such as for vehicle fleet management, using computationally and memory efficient computing infrastructures.

### BACKGROUND

In the art, capital asset management typically relates to the management of physical assets with the goal of minimizing capital expenditures and operating expenses by maximizing the useful life of an asset. Assets and their expenses are tracked to determine an optimal time to replace the asset where the replacement cost is justified by, for example, the ongoing operating or maintenance costs of the asset. One example of such assets are corporate owned vehicles forming part of a fleet of vehicles.

Typically, such resource planning has been performed using spreadsheets, or the like, due to the heavy amount of data, calculations, iterations and analysis being required. Users in an asset owning entity build their own version of source data from a source data database on their local PCs, and then create their own local scripts or equations to operate on the data. This is particularly the case due to the level of customization required for each individual instance of a group of assets which need to be managed. This approach leads to serious performance problems (for both the set of local PCs and the source data database), memory problems (primarily for the local PCs) and data updating and accuracy problems. These problems are serious enough that accurate analysis often takes prior art solutions several days, even under the guidance of a skilled user.

There thus remains a need for a resource planning system which can be applied to capital assets that offers computationally and memory efficient, accurate capital expense and life cycle planning tools.

### SUMMARY OF THE INVENTION

In one embodiment of the invention, there is provided a system for physical asset resource planning including a CAM (capital asset management) application server configured to execute a life cycle module for generating an asset life cycle model based on user inputs customizing the model for each instance of its execution; and execute a life cycle calculator for generating an annual cost for an asset based on the life cycle model and on a dataset received from the CAM database server. The CAM report server includes a processor configured to execute a presentation module for displaying results of the life cycle module and the life cycle calculator to a user. The CAM database server is configured to store a plurality of datasets related to a plurality of assets and to provide data to the CAM application server for executing the life cycle calculator and to provide data to the CAM report server.

In one aspect of the invention, the CAM application server and the CAM report server communicate to implement a presentation layer in a model-view-controller arrangement, wherein the model component manages data, logic and rules of a CAM application, the view component provides an output representation of information and the controller component accepts inputs from a user and converts the inputs to commands for the model or view components.

In another aspect of the invention, the system includes a fleet management system in data communication with the CAM database to provide the plurality of stored datasets.

In another aspect of the invention, the fleet management system includes a telematics interface, a maintenance interface and a source data database for temporarily storing data received from the telematics interface and from the maintenance interface; and wherein the telematics interface receives data from one or more sensors located on each asset and the maintenance interface receives data from a maintenance shop computer performing maintenance on each asset.

In another aspect of the invention, the CAM application server provides a service layer including an interface for exchanging data with the presentation layer, a business logic model and an object relational mapping module.

In another aspect of the invention, the business logic module defines fixed parameters and rules of the CAM application.

In another aspect of the invention, the object relational mapping module defines the relationship between different data sets and objects to which the business logic module is applied.

In another aspect of the invention, wherein the life cycle module applies a mean annual cost equivalent life-cycle model to determine an optimal time to replace one or more assets.

In another aspect of the invention, the mean annual cost equivalent is determined from

$$( {MACE}_{R} ) = [ P - \frac{{S}_{R}}{{( 1 + i )}^{R}} + {\sum }_{t = 1}^{R} \frac{{X}_{t}}{{( 1 + i )}^{t}} ] [ \frac{{i ( 1 + i )}^{R}}{{( 1 + i )}^{R} - 1} ]$$

where; i=discount rate
P=purchase price at t=0
t=year (numeral indicator)
S=resale or salvage value
R=year of replacement
X=sum of the year's costs (excluding depreciation, alternative cost of capital and inflation)

In another aspect of the invention, the CAM application server enables users to generate custom life-cycle models based on user-defined parameters modifying the mean annual equivalent cost model.

In another aspect of the invention, the user defined parameters include one or more of Labor Rate, Cost Per Downtime Hour, Cost per Energy Unit, Total Capitalized Cost, Depreciation Type, Salvage Percentage, Depreciation, Discount Factor, Include Warranty Costs, Maximum Years to Display and Utilization Meter Unit of Measure.

In another aspect of the invention, the CAM application server, via the life cycle module, is configured to remove data outliers from the data received from the CAM database server.

In another aspect of the invention, data outliers are removed based on a sensitivity level determined by a user.

In another aspect of the invention, the life cycle calculator accepts as a user-input a filter of categories of assets to be included in the analysis.

In another aspect of the invention, the user selects a depreciation method for applying depreciation to the analysis.

In another aspect of the invention, the CAM report server is configured to enable the viewing of annual costs for each asset based on the life cycle model.

In another aspect of the invention, the CAM report server accepts user inputs via the presentation layer to display reports and visualizations based on user-selected formats.

In another aspect of the invention, the CAM application server uses the generated data to determine an optimal replacement year for each of the assets.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a diagram of a prior art system for capital asset management;

FIG. 2 shows a hardware arrangement and configuration according to one embodiment of the invention.

FIG. 3 illustrates an exemplary computer system which may be used to implement one or more of the hardware elements in FIG. 2

FIG. 4 is a high level depiction of the software architecture enabled by parts of the hardware arrangement of FIG. 2.

FIG. 5 shows an exemplary system for managing a fleet of vehicles.

FIG. 6 shows a schematic representation of a control system aboard each of the vehicles in the fleet of FIG. 5.

FIG. 7 shows the communications infrastructure of the fleet management system.

FIG. 8 illustrates the differences between using a total period cost analysis and an average total period cost analysis for determining asset costs.

FIG. 9 shows an exemplary life-to-date repair cost chart for determining cumulative maintenance costs.

FIG. 10 shows a user interface showing data imported from the dataset.

FIGS. 11-16 show user interfaces for model parameters and other options being set prior to running the analysis.

FIGS. 17-27 show various presentation and reporting options enabled by the invention.

### DETAILED DESCRIPTION OF THE INVENTION

Having summarized the invention above, certain exemplary and detailed embodiments will now be described below, with contrasts and benefits over the prior art being more explicitly described.

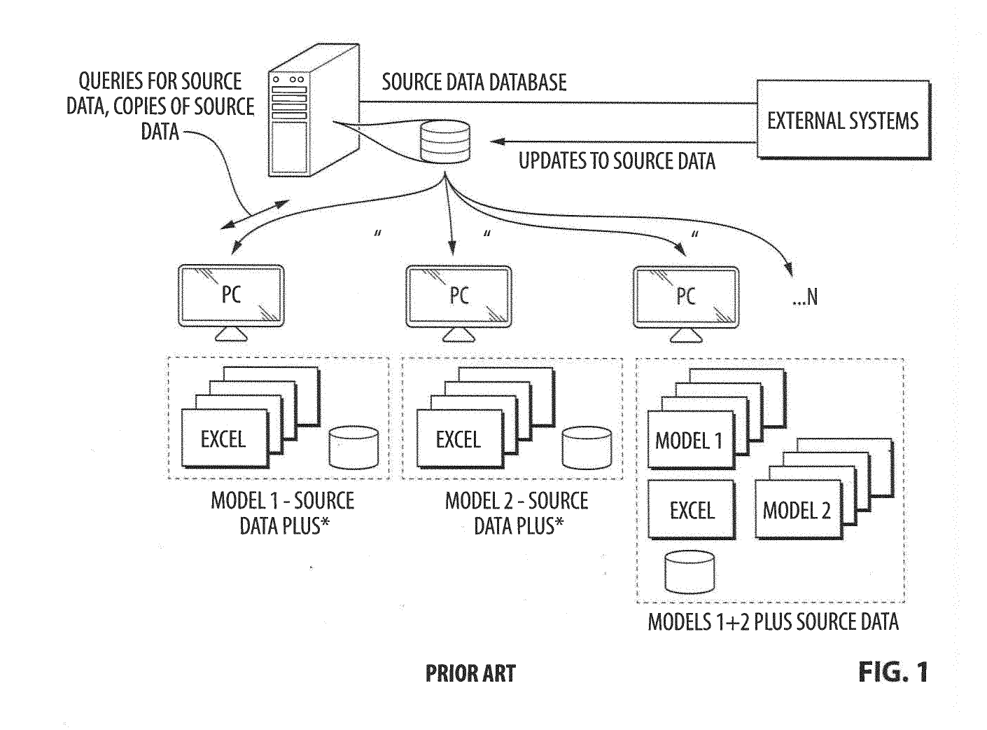

Referring now to FIG. 1, there is shown a prior art system 100 for capital asset management. Users, such as fleet operator workers, have one or more personal computers (PCs) 102 they would use to perform their tasks. One of these tasks may be capital asset management (CAM) tasks. In order to perform CAM tasks, the user connects, from their PC 102, to a source data database 104, such as via Crystal Reports™ or other database query tool. They might then extract data into a local software-accessible file, such as an Excel™ or Access™ file. Extracting data involves generating original queries, needing to know what information they would need to perform the task and how to structure the query. Additional data may be obtained by either source data database 104 or PCs 102, such as inflation rates, allowed capital depreciation percentages, and the like. These may also be incorporated into the models. Further, a set of assumptions and configurations may be included and set up in the Excel™ files, with the possibility of adjusting the assumptions and configurations (which is one of the reasons multiple models may exist, to consider various sets of assumptions and configurations). They might then want to build and run one or more models of the CAM task (such as Model 1 and Model 2). As shown, the two models may be in the same file (110) or in two separate files (108), each approach having different impacts on processing speed and storage requirements (for example where 110 may only keep one copy of the data but then may be slower to update and calculate as changes to the data cause two models to need updating). Of course while the models are being built and used various external systems 106 may be updating the data in the source data database 104; such changes do not get reflected at the PCs 102 and are thus not in the models, unless the data is re-imported into 108 or 110.

By way of example, an operator may want to perform a life cycle analysis for “½ ton trucks”. To do such a task the operator may need a “job table”, a “odometer table”, a “downtime table”, a “fuel table” and a “capital asset value table”—all of which must be queried and then copied into the Excel™ file. Then the operator would need to create a series of calculations, operating on various cells, to create a set of sheets (often four or more) to capture the data required for the task, with one row in each of the four sheets relating to a particular “½ ton truck”. These lookups across the sheets from the source data database would be repeated for each “½ ton truck” in the fleet (often hundreds or even thousands of such trucks) to create one row, in each of the four sheets, for a given truck. So the four sheets might have several thousand rows. Then a dashboard sheet would be created in the Excel file and various formulas would be applied against all of the data in the four sheets, to create a dashboard that included the life cycle analysis of the “½ ton trucks”. Of course the assumptions and configurations would form part of the calculations that would be applied against the data in the four sheets as the calculations were being performed. Having done this for “½ ton trucks”, to at least establish a first model (not having made any changes to assumptions or configurations) the operator would then turn their attention to “¾ ton trucks” and repeat the entire process. And do so for each type of vehicle or asset/equipment that is part of the life cycle analysis (where, for capital management, as described herein, each type may be required to be done simultaneously so an overall plan, for all of a fleet operator's assets, can be created). Returning back to the baseline models that now exist, an operator may want to change an inflation rate, interest rate, or a depreciation percentage, for one or more vehicle types. To do so they would manually change each configuration in the Excel™ file, for each vehicle type, and have the resulting calculations performed (required to update the dashboard) run. This could result in tens of thousands of individual cells being updated each time a change is made. In practice making a change often takes so long to compute that operators leave their PCs 102 for a few minutes to return when the calculation has fully completed. The resources required of the PCs 102 was simply too high to be viable for a PC and the time taken to compute was simply too high to allow efficient operator work.

The phrase capital asset management (CAM) is used throughout this description interchangeably with physical resource planning and management. More generally, CAM tasks according to embodiments of the invention may involve any one or more of the following:

1) Optimizing the entire life-cycle of a group of physical assets, such as a vehicle fleet by:
(a) Request: Make asset selections easier with a pre-defined selector list, customer request portal and approval and authorization workflows;
(b) Order: Streamline the procurement processes for assets, components services and accessories. Track the whole process including purchasing, allocation and delivery;
(c) Produce: Simplify complex processes and vendor communications, including receipt, acceptance and production issues for both external production and internal assembly;
(d) Dispose: Process the disposal of assets cost-effectively to handle logistics and preparation, track and reconcile the remarketing or auction process.

2) Using synergistic interactions between systems to help fleet operators understand data to make better decisions:
(e) Analyze: including graphs and visualizations to analyze all asset data, including economic life-cycle, repair history and trends by specific category;
(f) Forecast: Better plan for capital expenditures and long-term replacements, as well as forecasting maintenance costs and staffing levels;
(g) Plan: Prioritize replacements and new asset purchases and understand when to repair versus when to replace;
(h) Budget: Allocate funding wisely with a multi-year capital budget, track funding and expenses throughout the process.

Hardware Architecture

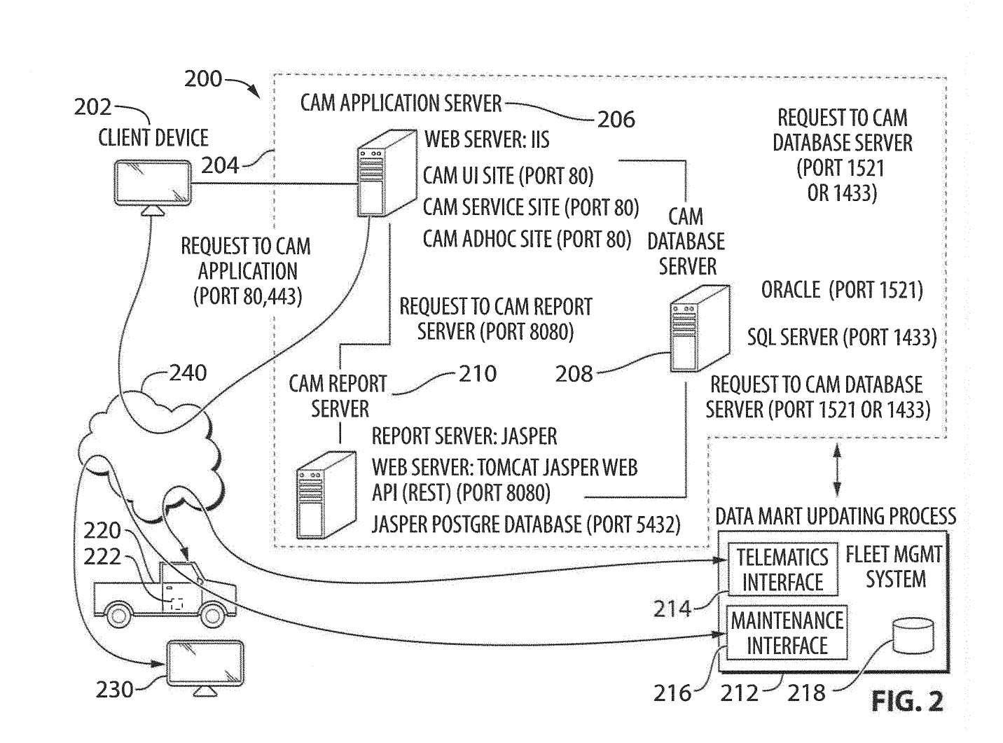

Referring now to FIG. 2, there is shown a system 200 for resource planning/management or capital asset management (CAM) including client device(s) 202, CAM system 204 which includes CAM application server (CAMAS) 206, CAM database server (CAMDS) 208 and CAM report server (CAMRS) 210, fleet management system (FMS) 212 which includes telematics interface 214, maintenance interface 216 and source data database 218, asset 220 further comprising on-board computer 222, maintenance shop computer 230 and fuel usage data source 232.

Vehicles in the fleet (exemplified by asset 220) may be substantially any type of vehicle (such as cars, buses, trucks, backhoes and the like) and are typically owned by a fleet owner making use of the invention herein described. Vehicles may include a mobile data terminal 222 (MDT). MDT may be any computing device that is on-board vehicle 220. MDT may communicate with other systems of vehicle, such as odometers, sensors, engines, speedometers, passenger load or capacity counters, vehicle signs, or other systems. MDT may be able to communicate with a communications network via, for example, an antenna or otherwise stores data on an onboard database assessable by the on-board computer 222. MDT 222 is preferably configured to communicate with FMS 212. FMS is also able to obtain vehicle data via telematics interface 214. Maintenance interface 216 is accessible via maintenance shop computer 203 (either physically or wirelessly) to capture maintenance-related data. Fuel usage data source 232 stores data related to fuel consumption of each vehicle.

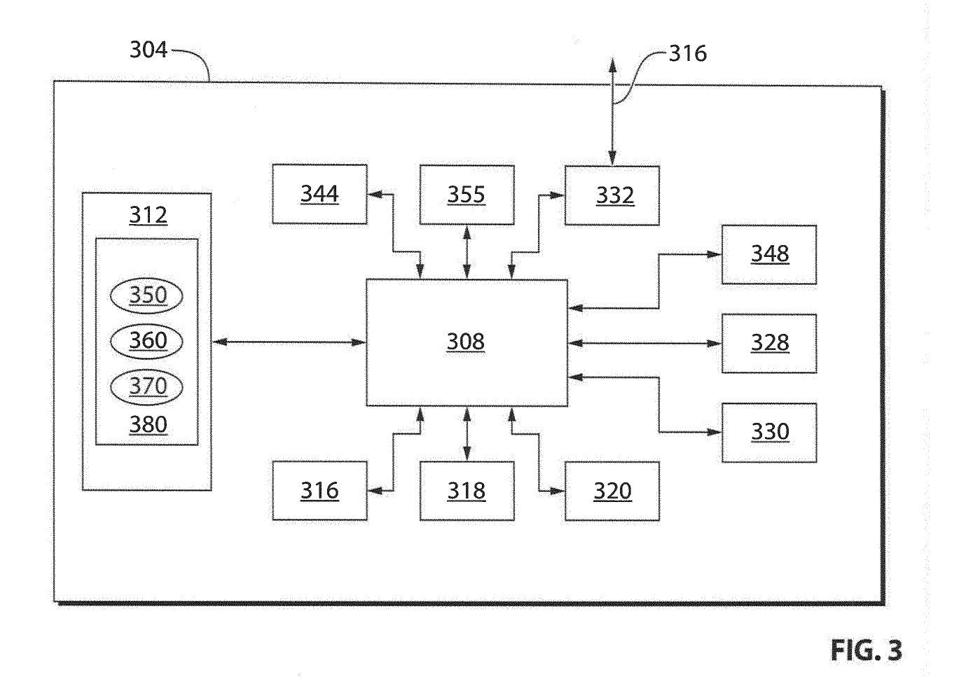

Client device 202, on board computer 222, maintenance shop computer 230, fuel data sources 232, CAMAS 206, CAMDS 208 and CAMRS 210 are all separate computer systems capable of interacting with each other as herein described. The interactions between these computer systems and the synergies generated by their interactions provide additional benefits to the invention. The computer systems forming the aforementioned elements are exemplified in FIG. 3, although individual computer systems may not include all of the elements in FIG. 3, where computing device 304 includes at least one main processor 308 that controls the overall operation of the computing device 304. The computing device 304 is interconnected with a non-transitory computer readable storage medium such as a memory 312. Memory 312 can be any desired combination of volatile (i.e., RAM) and non-volatile (i.e., ROM), including Electrically Erasable Programmable Read Only Memory (“EEPROM”), flash memory, magnetic computer storage device, or optical disc memory.

Computing device 304 also includes one or more input devices interconnected with main processor 308. Such input devices are configured to receive input and provide data representative of such input to processor 308. Input devices can include, for example, a keypad 316 and a pointing device 318. Thus, keypad 316 can receive input in the form of the depression of one or more keys, and can then provide data representative of such input to processor 308. In variations, a keyboard can be implemented as a soft keyboard relying on a touch screen, for example. A pointing device can be implemented as a computer mouse, track ball, track wheel, touchscreen, and the like. In some examples, such as with on board computer 222, a computing device can include additional input devices in the form of one or more additional buttons, light sensors, microphones and the like. Pointing device 318 can receive input in the form of movement, pressure or swipe gestures, and can then provide data representative of such input to processor 308 in the form of, for example, coordinates representing the location of a virtual cursor, the direction and/or velocity of a swipe gesture, and the like.

Computing device 304 further includes one or more output devices. The output devices of computing device 304 include a display 320. Display 320 includes display circuitry controllable by processor 308 for generating interfaces which include representations of data and/or applications maintained in memory 312. The display circuitry can thus include any suitable combination of display buffers, transistors, LCD cells, plasma cells, phosphors, LEDs and the like. When the input devices of computing device 304 include a touch screen input device, the touch screen (not shown) can be integrated with display 320. The output devices of computing device 304 can also include a speaker 328 interconnected with processor 308. Additional output devices are also contemplated.

Computing device 304 also includes a communications interface 332 interconnected with processor 308. Communications interface 332 allows computing device 304 to perform voice and/or data communications via a link 336, which can be wired and/or wireless, and, where appropriate, with or via a network such as 240. The communication interface 332 receives messages from and sends messages through link 336.

Computing device 304 maintains, in memory 312, one or more files containing a plurality of computer readable instructions and/or data. Typically, files are organized in accordance with a structure and logic referred to as a file system. In this illustrative example, file system 380 maintained in memory 312 represents the structure and organization of files accessible by computing device 304.

Files are typically stored in a non-volatile portion of memory 312 such as a solid state disk or a hard drive. In variations, the files can be stored in other portions of memory 312 such as in volatile memory or in a combination of different portions. In yet other variations, some of the files may be stored in memory or storage locations that are external to computing device 304, such as those maintained at network-based cloud storage (for example source data database 218 may be maintained externally). The location of files can also vary based on the operational state of the computing device 304. For example, files may be maintained in a non-volatile portion of memory 312 when the computing device is turned off. However, at least some of the files may be moved into a volatile portion of memory 312 as the computer device 304 is powered up, or otherwise rendered operational. In variations, files may be moved to volatile memory as the files are accessed by processor 308. Other combinations of memory 312 portions and operational states for storing files within memory 312 will now occur to a person of skill and are contemplated.

Alone or in combination, one or more files can form an application software or a module, such as software on CAMAS 206, CAMRS 210, CAMDS 208, FMS 212 (including telematics interface module 214 and maintenance interface module 216). For example, as illustrated in FIG. 3, computing device 304 stores a file manager application 350, resource planning applications 360 and an operating system 370. When processor 308 executes instructions contained in the one or more files forming applications 350, 360 and/or 370, processor 308 is configured to perform various functions prescribed by the computer readable instructions of the respective applications. It is contemplated that memory 312 can store a variety of additional applications, such as database applications, web browsing applications, and the like (not shown).

Memory 312 can also maintain various files representing information or data that can be utilized by various applications. For example, operating system 370 can utilize a registry data file in carrying out at least some of its functionality, the resource planning applications 360 can use data files while performing its functionalities. By way of example, the following table provides exemplary applications 350, 360:

| Computing | | |
|---|---|---|
| Device | Application | Brief Description |
| Client | Web browser | A web browser to access content and |
| Device | | functionality over a network. |
| CAMAS | Life cycle | Configuration, calculation, and analysis |
| | modelling and | of life cycles of assets. |
| | capital planning | |
| | application | |
| CAMDS | Database | All asset information is stored on |
| | | databases, such as Oracle and/or SQL |
| | | Server databases |
| CAMRS | Reporting | Runs and distributes all reports |
| | | launched from the CAMAS |
| On board | Vehicle | Collects vehicle information, such as |
| computer | application | via sensors, displays information for |
| | | vehicle driver, communicates vehicle |
| | | information. May be OBD-II |
| | | compliant. |
| FMS | Telematics | Receives vehicle information from the |
| | interface module | vehicle application on the on board |
| | | computer. |
| FMS | Maintenance | Receives maintenance information |
| | interface | from maintenance computers. |
| | module | |

An operating system such as operating system 370, is a collection of software and/or modules that manages the hardware resources of a computing device. An operating system also provides common services allowing other applications to make use of the hardware resources as appropriate. For example, an operating system can include file system services through which an application such as file manager 350 can access and manipulate the file system supported by the operating system. File system services allow access to basic file management operations by the operating system as well as by applications and modules operating at the computing device 304.

Typically, file system services are provided to help implement a file system in accordance with a specific file system protocol such as the New Technology File System (NTFS). The file system protocol determines the logic and structure according to which files can be organized, the format for naming a file, the format for storing the data and metadata associated with a file, as well as other file system policies that will now occur to a person of skill. In this illustrative example, files are stored in accordance with the file system 380 protocol.

Of course each computing device 304 may have different requirements for processors, memory, and applications. Such requirements may also vary based on the intended use of the computing device (for example the amount of data, expected response times, and number of concurrent users). Exemplary requirements for various computing devices are set out below, based on the numbers of concurrent user devices accessing the system simultaneously.

TABLE 1
Up to 50 Concurrent Client Device Users

| | CAMAS | CAMRS | CAMDS | |
|---|---|---|---|---|
| Operating | Windows Server | Windows Server | Any Oracle Supported OS | Windows 2003/2008 |
| System | 2003/2008/2012 | 2003/2008/2012 | | |
| Applications | Microsoft IIS | Jasper Report Server | Oracle 10 g | Oracle 10 g/Oracle 11 g |
| | CAM (UI, Service | (installs Tomcat web | | |
| | and Adhoc) | server) | | |
| | | | Oracle 11 g | SQL Server 2008 R2 |
| Processors | 1 Dual Core 2.8+ GHz | 1 Dual Core 2.8+ GHz | 1 Dual Core 1.5+ GHz | I Quad Core 2.8+ GHz Xeon |
| | Xeon | Xeon | | |
| Memory | 4 GB minimum | 4 GB minimum | 4 GB minimum | 4 GB minimum |
| Disks | 3 × 73 GB SCSI-3 | 3 × 73 GB SCSI-3 | 100 GB SCSI-3 | 100 GB SCSI-3 |
| | Raid-5 (15k RPM) | Raid-5 (15k RPM) | Raid-1 (15K RPM) | Raid-1 (15K RPM) |
| Network Card | 1 Gigabit Ethernet | 1 Gigabit Ethernet Card | 1 Gigabit Ethernet Card | 1 Gigabit Ethernet Card |
| | Card | | | |
| Virtual | Yes | Yes | Yes | Yes |
| Machine | | | | |
| Load Balance | Yes | No | No | No |
| Capable | | | | |
| Other | | | Backup Library | Backup Library |

TABLE 2
Up to 200 Concurrent Client Device Users

| | CAMAS | CAMRS | CAMDS | |
|---|---|---|---|---|
| Operating | Windows Server | Windows Server | Any Oracle Supported OS | Windows 2003/2008 |
| System | 2003/2008/2012 | 2003/2008/2012 | | |
| Applications | Windows IIS | Jasper Report Server | Oracle 10 g | Oracle 10 g/Oracle 11 g |
| | CAM (UI, Service | (installs Tomcat web | | |
| | and Adhoc) | server) | | |
| | | | Oracle 11 g | SQL Server 2008 R2 |
| Processors | 2 Quad Core 2.8+ GHz | 2 Quad Core 2.8+ GHz | 2 Dual Core 1.5+ GHz | 2 Quad Core 2.8+ GHz |
| | Xeon | Xeon | | Xeon |
| Memory | 4 GB minimum | 4 GB minimum | 8 GB minimum | 8 GB minimum |
| Disks | 3 × 73 GB SCSI-3 | 3 × 73 GB SCSI-3 | 200 GB SCSI-3 | 200 GB SCSI-3 |
| | Raid-5 (15k RPM) | Raid-5 (15k RPM) | Raid-1 (15K RPM) | Raid-1 (15K RPM) |
| Network Card | 2 Gigabit Ethernet | 2 Gigabit Ethernet Card | 2 Gigabit Ethernet Cards | 2 Gigabit Ethernet Cards |
| | Cards | | | |
| Virtual | Yes | Yes | Yes | Yes |
| Machine | | | | |
| Load Balance | Yes - optional | No | No | No |
| Capable | | | | |
| Other | | | Backup Library | Backup Library |

TABLE 3
Greater than 200 Concurrent Client Device Users

| | CAMAS | CAMRS | CAMDS | |
|---|---|---|---|---|
| Operating | Windows | Windows Server | Any Oracle Supported OS | Windows |
| System | 2003/2008 | 2003/2008/2012 | | 2003/2008 |
| Applications | Windows IIS | Jasper Report Server (installs | Oracle 10 g | Oracle 10 g/ |
| | CAM (UI, | Tomcat web server) | | Oracle 11 g |
| | Service and | | | |
| | Adhoc) | | | |
| | | | Oracle 11 g | SQL Server 2008 |
| | | | | R2 |
| Processors | 2 Quad Core | 2 Quad Core 2.8+ GHz Xeon | 4 × 1.5+ GHz | 4 Quad Core 2.8+ GHz |
| | 2.8+ GHz Xeon | | | Xeon |
| Memory | 8 GB minimum | 8 GB minimum | 32 GB minimum | 32 GB minimum |
| Disks | 3 × 73 GB SCSI-3 | 3 × 73 GB SCSI-3 | 2 TB Raw SAN Installed (Raid-1) for | 2 TB Raw SAN |
| | | | Data | Installed (Raid-1) |
| | | | | for Data |
| | Raid-5 (15k | Raid-5 (15k RPM) | | |
| | RPM) | | | |
| Network Card | 2 Gigabit | 2 Gigabit Ethernet Card | 4 Gigabit Ethernet Cards | 4 Gigabit Ethernet |
| | Ethernet Cards | | | Cards |
| Virtual | Yes | Yes | Yes | Yes |
| Machine | | | | |
| Load Balance | Yes - Add 1 | No | No | No |
| Capable | Server/200 Users | | | |
| Other | | | Backup Library | Backup Library |

Software Architecture

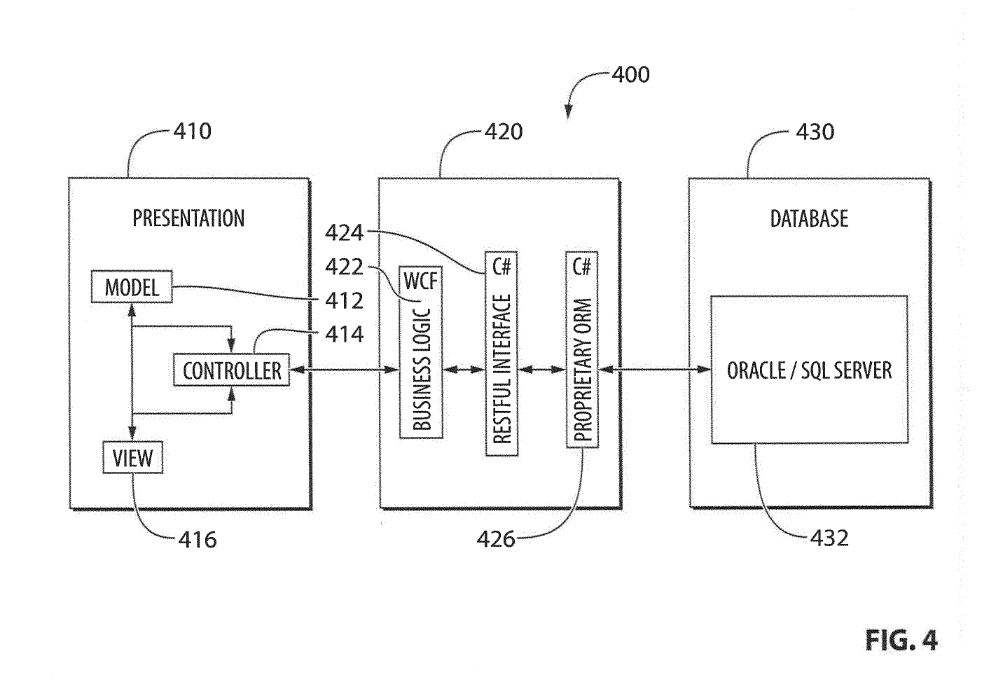

Referring now to FIG. 4, there is shown a representation of the software and technical architecture enabled by the hardware configurations described above. In one practical implementation, the hardware enables a full suite CAM application, which includes three distinct software layers for executing the CAM functionality, including presentation layer 410, service layer 420 and database layer 430.

The presentation layer 410 is that which an end-user has direct interaction with, and preferably follows a model-view-controller arrangement. A model component 412 directly manages the data, logic and rules of the CAM application. A view component 414 can be any output representation of information, such as charts or diagrams, and may include multiple views or different way of presenting information. A controller component 416 accepts inputs and converts these inputs to commands for the model 412 or view 414 modules. The model component 412 stores data that is retrieved according to commands from the controller 416 and displayed on the view 414. The view generates new output in response to user-based changes in the model. The controller 416 can send commands to the model to update the model's state. It is also capable of sending commands to the view 414 to change the view's presentation of the model. This arrangement facilitates the user's interaction with the CAM application and provides for a significantly faster, and more resource efficient manner of handling the data required for large scale CAM applications. In the preferred embodiment, the presentation layer is implemented on an Internet-accessible page, and accessible via any web browser.

The service layer 420 includes an interface for communicating with the presentation layer, such as a RESTful interface 422, a business logic module 424 and an object relational mapping (ORM) module 426. The service layer 420 is generally only accessible by administrators of the system, the service provider or technical personnel required for updating the core infrastructure. The RESTful interface 422 is generally known in the art as a means for interfacing between a back-end system and a user-facing system, and thus not described in further detail herein. The business logic module 424 defines parameters of the CAM application that are fixed with respect to a specific fleet. The ORM module 424 defines the relationship between different sets of data and objects which feed into the business logic module 424, to which the model on the presentation layer is applied. Finally, the database layer 430 includes a database 432, supported by Oracle or an SQL server, for example.

In the preferred implementation, the CAM layers are arranged such that a single request to the CAM presentation layer via a user interface returns the entire CAM user interface to the requesting clients' browser. Data for the user interface (ie. the presentation layer) may be retrieved via a jQuery AJAX request from the service layer 420. Each AJAX request would be digitally signed and authenticated in the service layer 420. It will be evident that the presentation layer 410 does not communicate directly with the database layer 430. Only the service layer 420 can access the database layer 430. With reference to the hardware in FIG. 2, this translates into the CAMAS and the CAMRS being able to access the CAMDS, but the presentation layer accessible on the client device interacts with the CAMAS only.

Obtaining Data from Vehicles in the Fleet

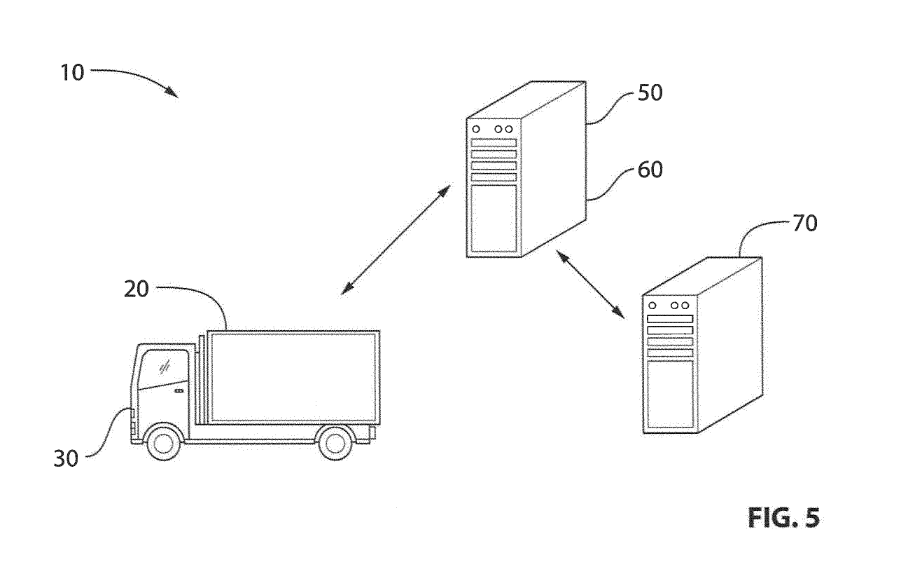

Referring now to FIG. 5, there is shown a system 10 for managing a fleet of vehicles 20, from where relevant data may be extracted for the CAM functionality as herein described. The system 10 includes a control unit 30 on one or more vehicles in the fleet of vehicles, a data collection unit 40 on one or more vehicles in the fleet of vehicles in communication with the control unit 30, a server 50 having an operational database 60 for receiving data from one of the control unit 30 and the data collection unit 40, and a telemetry module 70 having access to the operational database 60 for initiating an action based on an analysis of data on the server 50. The control unit 30 is preferably an onboard computer system provided on each vehicle.

The data collection unit 40 (generalized as MDT 222 in FIG. 2) also be computer system in accordance with that described above and adapted to receive and store data from one or more sensors on each vehicle, or from other vehicle data sources, as will be described in more detail below. The server 50 preferably includes non-volatile storage means on where the operational database 60 is stored to maintain data from each of the vehicles in the fleet. The telemetry module 70 may also be located on the server, but may, alternatively, be located on another computer system having communication access to the server 50.

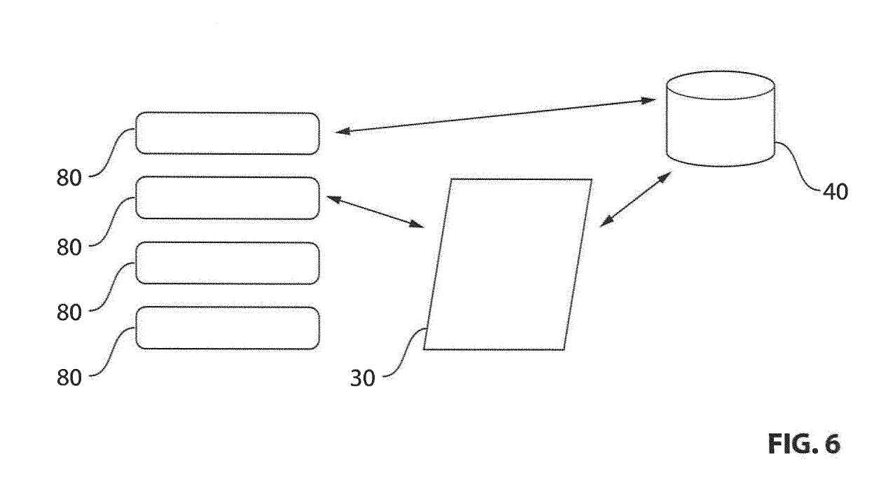

Referring now to FIG. 6, there is shown a schematic representation of a preferred embodiment of a control unit 30 as will be provided on one or more vehicles in the fleet. The control unit 30 is preferably part of, or in and of itself, an on-board computer on each vehicle. The control unit 30 may variably be referred to as an engine control unit 30 and is adapter to manage vehicle performance, and capture vehicle operating parameters from one or more sensors 80 provided on each vehicle in the fleet. The vehicle parameters may include one or more of odometer reading, fuel level, engine status, vehicle speed, vehicle location, system pressure, vehicle emissions, vehicle power status, vehicle idle status, engine diagnostic trouble codes, vehicle acceleration and vehicle engine parameters. Preferably, the data captured by the control unit 30 will be stored on the data collection unit 40 in a format suitable for wireless communication. In a preferred embodiment, the data is stored in hexadecimal format and transmitted to the operational database 60 on the server 50 using a standard wireless protocol. The control unit 30 may further provide information related to sensor triggered diagnostic trouble codes, such as fault mode indicators, specific occurrences of vehicle problems and status indicators for various vehicle on-board systems. As will be appreciated by those skilled in the art, any software or module as herein described, such as the telemetry module 70, that is accessing data, will include thereon instructions on converting the data string into a format useable as required, or to otherwise extract only data relevant to a particular operation being performed.

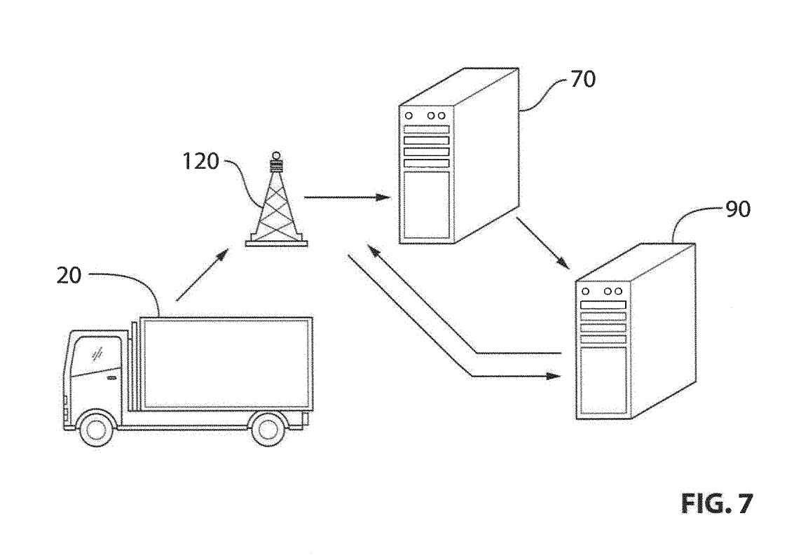

Communication means provided on the control unit 30 may preferably operate in active and passive modes, depending on the location and use of a particular vehicle in the fleet. In the active mode, as shown in FIG. 7, the communications infrastructure preferably uses CDMA/GRPRS modems over a wireless network 120, Local Area Networks (LAN) or alternatively, satellite-based systems for use in remote areas. Communication between the data collection unit and the wireless network is thus always active, or active on predetermined intervals. Two-way communication with components on the vehicle is also possible providing, for example, remote shutdown and vehicle tracking options. Generally, operating in the active mode incurs generally costlier network access charges. Furthermore, the active communication mode allows for two-way communication to, for example, confirm receipt of a problem being logged, or to send out GPS coordinates.

In the passive mode, communication occurs via Wi-Fi, 900 MHz or RFID based networks, for example. Communication is transmitted on an event-based arrangement, such as vehicle on/off, scheduled transmissions, driver triggered communication or proximity to a receiver. Two-way communication is limited in passive mode. On-demand mode functions when there is a direct connection to the vehicle, for example, when used with vehicle diagnostic tools. It is also contemplated that a combination of active and passive communication modes may be used, depending on the nature of the communication. In the passive mode, it is further contemplated that a data collection terminal 110, shown in FIG. 5, is provided and located proximate a location where one or more vehicles in the fleet of vehicles is parked. The control unit 80 is then adapted to collect data from the data collection unit and communicate it to the data collection terminal. In this passive mode, a technician may connect a diagnostic computer to the vehicle and manually reviews vehicle fault codes to identify issues. Optionally, the fault codes can generate predetermined work requests or be linked otherwise to work orders. Once the repair is completed, the technician clears the codes and optionally performs a quality inspections.

The telemetry module 70 is adapted to receive, or otherwise access, data from the control unit and provides for various functions and abilities as will be described in more detail further below. In one embodiment, shown in FIG. 4, the telemetry module 70 communicates with a service provider module 90, stored on a service provider computer system that initiates an action to be carried out with respect to a particular vehicle. For example, the telemetry module 70 may make a determination that a particular type of maintenance is needed on a vehicle and passes this information on to the service provider module 90 which initiates the maintenance being done, for example by sending out a work order. Particular examples of implementation are provided below.

The telemetry module 70 can be used to initiate a number of actions, such as maintenance actions. In the preferred embodiments, the telemetry module 70 further provides the ability for maintenance personnel, for example, to review data from any particular vehicle in the fleet, a group of vehicles in the fleet, or of the fleet as a whole and to further analyze the data or initiate specific actions based on this analysis. The results achieved by the system as herein described allows for improved efficiencies in the management of a large number of vehicles in a fleet.

It will be appreciated by one skilled in the art that the availability of telemetry data and use according to the present invention generally improves fleet management, and in particular the life-cycle improvements made possible by the ability to have near real-time fuel and usage data which improves the accuracy of a life cycle model and reliability of decisions made based on these models. The prior art's reliance on spreadsheet methods typically require reliance on information that is weeks or months old. More specifically, a better picture of vehicle usage and demand may be provided. For example, the telemetry module may analyze the fuel consumption of a particular vehicle in the fleet, a group of vehicles in the fleet and of the entirety of the fleet. In this regard, vehicle performance and driving habits may be optimized to reduce fuel consumption, by, for example, identifying vehicles and driving habits where fuel consumption is above particular benchmark numbers.

In the preferred embodiment, the telemetry module has access to sensor data measure various operating parameters of each and every vehicle, as described above. The telemetry module also has access to vehicle diagnostic codes as output by the engine of each vehicle. With regards to maintenance, unreported problems may be identified before becoming failures, by way of these sensor measurement. Therefore, maintenance schedules and actions can be predicted and performed on a preventative schedule based on an overall fleet schedule. It is also possible to establish condition-based maintenance programs in addition to preventative maintenance programs and to use vehicle performance data to improve warranty coverage and vehicle component selection. The present invention also allows for additional monitoring or driver actions and behavior, for example in monitoring route deviations or collecting operating data to identify poor driving habits. When accidents do occur, collected parameter data may be used to analyze and interpret the vehicle state at the time of the accident. For insurance and regulatory purposes, a log is easily created to show times of service, pre-trip inspections, emissions monitoring and fuel tax reporting.

Furthermore, better operational management of vehicles in the fleets is possible by using GPS tracking and meter data to present a truer picture of vehicle use and demand. Frequent and accurate meter readings are made possible, as are hourly and daily readings to confirm use. The number of vehicle starts and stops and trips made per day may also be monitored.

In terms of fuel management, the system herein described may be used for tracking and tracing of leakage points in fuel consumption, including monitoring engine idle time, monitoring emission/engine parameters to improve performance, monitoring driver behavior related to an increase in fuel consumption, including high acceleration, speed and hard braking and allows for the tracking of unnecessary miles. This information may then be used to anticipate when a vehicle may be ready for its next scheduled maintenance and to account for and plan for this maintenance at appropriate times.

The maintenance management functions use vehicle parameters and diagnostic trouble codes to drive maintenance procedures for individual vehicles. Accordingly, immediate action may be taken to fault code alerts and a condition-based maintenance approach may be implemented. For example, alerts may be monitored to schedule service to avoid unreported problems, and the fault codes may be linked to maintenance records. Using a condition-based maintenance approach involves monitoring operating parameter thresholds to trigger maintenance activities and incorporating parameter data into failure analysis to establish flags for future failures. The parameter data may also be incorporated into warranty claims and both parameter and performance data may be used for vehicle and/or component selection purposes.

Accordingly, the complete maintenance cycle of vehicles in a fleet may be monitored, controlled, and documented using the system and method herein described. Various telemetric applications have been described using passive, active or on-demand communication to transmit data relevant for maintenance purposes including generating work requests, viewing historical data and collecting operational data for all vehicles in the fleet.

The CAM Life Cycle Model Algorithm

Broadly, the CAM applications and facilities enabled by the invention include developing a life cycle model that makes optimal use of the hardware arrangement described above and using the results of the life cycle model, in part, to determine an asset replacement model. The life cycle model improves upon prior art life cycle models by virtue of the innovative hardware and software arrangements as described above. The general state of the art life cycle model is exemplified by models put forward by the American Public Works Association (APWA) and by M. C. Vorster in the 1970s, both of which are summarized below, and key elements of these prior art methods which are improved upon by the present invention are discussed in more detail.

The APWA identifies a number of factors as inputs into their life cycle model which cumulatively add towards a unit's cost. These include depreciation, operations, maintenance, downtime, interest, alternative capital value, inflation, obsolescence, operator training and carrying parts/inventory. These factors are then used to calculate the total period cost for all periods in a lifecycle, which may then be plotted on a chart. The lowest total period is used to determine the optimal replacement period. The APWA model can be applied based on total yearly costs or using a mean period cost analysis.

For example, consider a 6-year analysis of a sample vehicle within a fleet whose total dollar costs for each of the above-noted factors total as follows:

| | Total |
|---|---|
| Year | Yearly Costs |
| 1 | 3000 |
| 2 | 2600 |
| 3 | 2400 |
| 4 | 2500 |
| 5 | 3100 |
| 6 | 3600 |

This analysis leads to the conclusion of replacing this vehicle in its third year of operations according to the APWA model total yearly costs analysis.

When using the mean period cost analysis, the costs are as follows, and would lead to replacing the vehicle in the fourth year of operations:

| | Total | Avg. |
|---|---|---|
| Year | Yearly Costs | Yearly Costs |
| 1 | 3000 | 3,000 |
| 2 | 2600 | 2,800 |
| 3 | 2400 | 2,667 |
| 4 | 2500 | 2,625 |
| 5 | 3100 | 2,725 |
| 6 | 3600 | 2,867 |

The mean period cost for a replacement cycle R can be calculated as follows:

$$Mean Period Cost for replacement cycle R \\ ( {MPC}_{R} ) = \frac{P - {S}_{R} + {\sum }_{t = 1}^{R} {X}_{t}}{R}$$

where: P=purchase price at t=o
   t=period (numeral indicator)
   S=resale or salvage value
   R=period of replacement
   X=sum of the period's costs (excluding depreciation, alternative costs of capital, and inflation)

Or put more simply,

$${MPC}_{R} = \frac{{D}_{R} + {CRT}_{R}}{R}$$

Where
D_{R} is the amount of money lost to depredation at period R
CRT_{R} is the total cumulative costs spent on operations, maintenance, downtime, obsolescence, operator training and carrying inventory at period R
R is the period of replacement

And to summarize,

$${MPC}_{R} = \frac{Total Cumulative Costs At A Given Period}{Number of Periods Elapsed Through The Given Period}$$

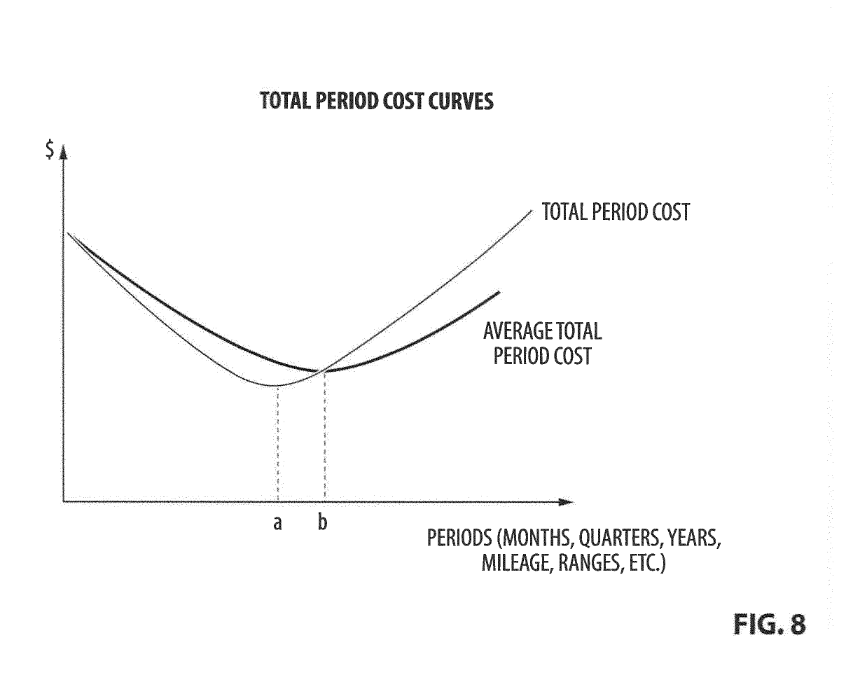

When comparing the mean period cost analysis versus the total period cost analysis, it is worthwhile to note that both are neutral of the period type being used. That is, they can be used for any user-defined period, such as years, months, usage, etc. It is generally accepted that the mean period cost approach is a better indicator of the optimal replacement period. A comparison of the two approaches and their results is shown in FIG. 8.

As will be apparent to those skilled in the art, various modifications and variations to the system and method herein described will be possible, without departing from the spirit of the invention. It will also be apparent to those skilled in the art that the present invention may be used for vehicle rental purposes, vehicle sharing purposes, organizational vehicle control, and provide information and data as required and adapted to each of these types of business.

Another approach is referred to as the mean period cost equivalent analysis. This approach can only be used for analysis over time, but can be used for analysis by usage when usages are converted to time equivalents. The mean period cost equivalent approach is a discounted cash flow model which factors in costs for interest and alternative capital value, but does not factor in inflation. The mean period cost equivalent (or the mean annual cost equivalent, where period is set as annually) can be expressed as follows:

$$( {MACE}_{R} ) = [ P - \frac{{S}_{R}}{{( 1 + i )}^{R}} + {\sum }_{t = 1}^{R} \frac{{X}_{t}}{{( 1 + i )}^{t}} ] [ \frac{{i ( 1 + i )}^{R}}{{( 1 + i )}^{R} - 1} ]$$

where; i=discount rate
P=purchase price at t=year (numeral indi cator)
S=resale or salvage value
R=year of replacement
X=sum of the year's costs (excluding depreciation, alternative cost of capital and inflation)

In terms of determining the optimal replacement period, the same approach is used, where the asset is replaced in the year with the lowers mean equivalent annual cost. Consider the example below, where the replacement is made in the fourth year:

To summarize, the mean period cost equivalent is calculated as

$$( Discounted Depreciated Cost + Cumulative Discounted Total Costs ) * ( Capital Recovery Factor )$$

Discounting is defined as the operation of evaluating the present value of future cash. The discount rate is the highest alternative investment rate available.

In order to determine the discount factor, that is the factor by which the current cash flow must be multiplied in order to obtain the present value, the following formula is applied:

$${DF}_{t} = \frac{1}{{( 1 + i )}^{r}}$$

Where i=Interest rate and r=Replacement period

The Capital Recovery Factor is the factor by which discounted cash values must be multiplied by to obtain the present value of the potential alternative capital value, and can be expressed as:

$${CRF}_{n} = \frac{{i ( 1 + i )}^{r}}{{( 1 + i )}^{r} - 1}$$

Where i=Interest rate and r=Replacement period

In addition, the maintenance history of each vehicle in the fleet is to be factored in to the life cycle analysis. It is notable that there is declining maintenance costs at the end-of-life of each vehicle. These can be caused by a number of factors, including major repairs being avoided (i.e., the vehicle can be sold), vehicle usage declines as the vehicles age, better conditioned vehicles are those that kept for the longest time. This leads to skewed data in which maintenance cost trends appear to decline at the end-of-life, and can lead to negative maintenance cost curves across the fleet. The solution to this peculiarity is to base maintenance tends on costs from first-line life, and to forecast future costs beyond the end of life.

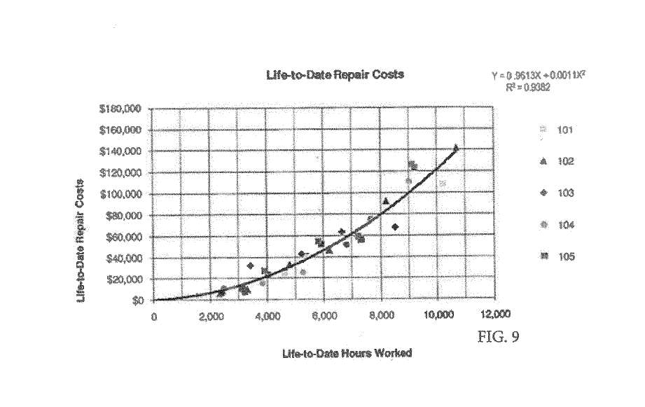

One way of doing this is to use what is referred to as the Vorster Method, in which a second degree polynomial regression is used to generate a trend of cumulative maintenance costs. The CAMAS of the present invention extends this to trend the cumulative costs as well. FIG. 9 shows an exemplary life-to-date repair cost chart for determining cumulative maintenance costs. The Vorster Method uses a second degree polynomial regression to generate the trend curve that is hard-coded into the method.

In contrast the method of the CAMAS of the present invention uses a multi-step curve fitting process made possible by the hardware and software architecture described above. In particular, the CAMAS using a curve fitting process that (a) starts with a second degree polynomial regression fit and (b) generates an increase in the degree of the polynomial to compare the coefficient of determination (R²) to the previous coefficient of determination and (c) repeats steps (a) and (b) until the increase in R² is less than 25%.

Another improvement provided by the present invention is the inclusion of inflation to inflate historical values to present day values by compounding inflation rates for each kind of cost for each month as reported by government agencies in the jurisdiction of operation (for example, the Federal Reserve Bank in the United States). For example, the historical labor costs are adjusted using US wage inflation rates from “Total compensation for All Civilian workers in Installation, maintenance, and repair”, as found at https://research.stlouisfed.org/fred2/series/CIU1010000430000I.

Another improvement in the model is the introduction of a median absolute deviation factor which provides a robust measure of the variability of a univariate sample of quantitative data, and can be used to eliminate outlier data values. The median is a robust statistic with a higher breakdown point (defining the number of outlier values it takes to contaminate a dataset). Consider a data set of {1, 2, 3, 4, x}, where the average is x. The median has a breakdown point of N/2 where N is the number of elements in the dataset. In this dataset, the median is 3. N/2 is the maximum breakdown point value, after which one cannot tell the outliers from the real values.

The model of the CAMAS of the present invention improves upon the prior art by (i) the addition of historical inflation, (ii) using trended data to get an aggregate value for multiple assets, (iii) optionally includes the cost of downtime and fuel in operating costs, (iv) optionally bases maintenance costs on historical labor costs or standard current year labor rates, (v) optionally bases maintenance cost trending on data for current front-line life-cycle; and, (vi) optionally uses median absolute deviation functions to remove outliers from data sources.

Having thus summarized the model, the life-cycle calculator as would be assessable to a user on the presentation layer of FIG. 4 will now be described.

The CAM Life-Cycle Calculator

In order to ultimately determine the optimal replacement parameters for vehicles in the fleet, the CAM life-cycle calculator is executed by the CAMAS. The end user of the system has direct access to this calculator and is, in general, the user interface for the invention. For the purpose of the example that is discussed below, an equivalent annual cost model is shown, which is exemplified by the modified prior art model discussed above.

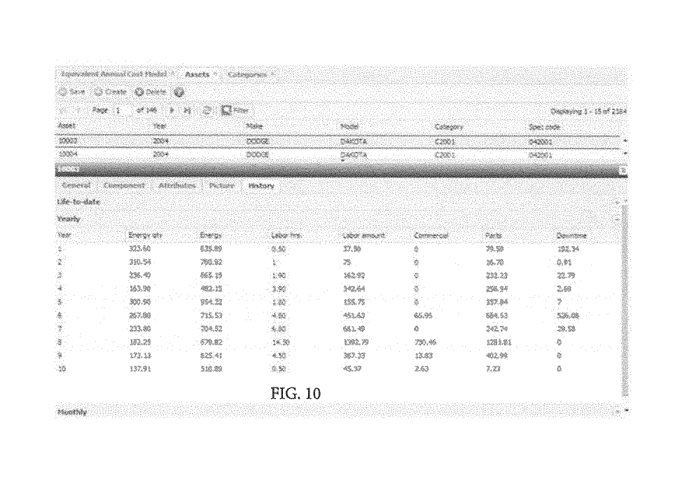

The first step which occurs when a user wants to determine the life-cycle of one or more vehicles in the fleet is to import data from the CAMDS for each of the vehicles being assessed. The user interface shows all data imported as shown in FIG. 10. The asset history is preferably aggregated into time intervals to reflect maintenance, energy, downtown and usage with their respective costs inflated to current year values in accordance with the model described above. As shown in FIG. 10, where “Asset 10003” is highlighted, a 10 year history is generated with cost values for each of the categories shown. The user is able to scroll through each of the assets, in this example there being 2184 assets with full histories to view. It is unlikely that a user would actually view all this data, but may wish to confirm certain values or do random data checks, if desired.

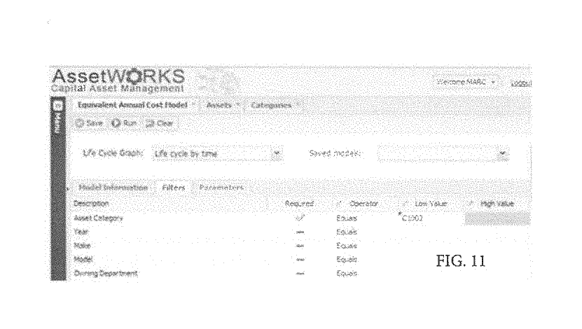

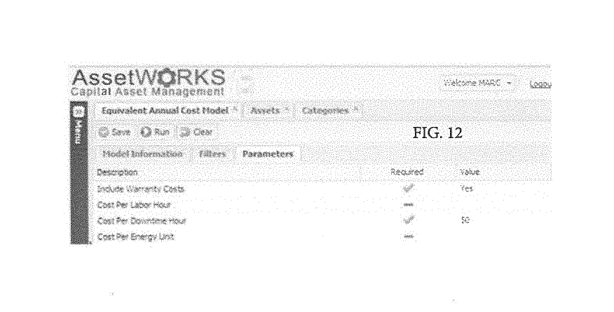

Optionally, a filter is next applied to select a subset of assets to be included in the analysis. FIG. 11 shows an exemplary user interface where a filter may be applied based on the category of asset, year, make, model and department. The category could be user defined beforehand and include assets with similar objectives. For example, in a fleet of trucks once category could be those trucks who travel across state lines only. Various other categories are contemplated included by type of payload being delivered, size of payloads, etc.

Next, model parameters are set, providing the option to a user to select all or a subset of the factors which go into making a cost determination, as per the model described in the preceding section. FIG. 11 shows an exemplary user interface where parameters can be selected by the user. Note that a parameter can be required or not, and even in the case of required parameters these can be excluded by setting the cost to 0. Costs that are not required may have data present from some but not all assets, whereas required costs must have data from each of the assets to return a valid result. Setting the cost to 0 results in the user's ability to exclude certain costs for a particular instance of the analysis. In the example shown, warranty costs are included. Labor costs are indicated as not being required but could be included as the cost is not set to 0. In the preferred embodiment, labor costs use historical labor costs, either as a direct input or calculated from historical labor time multiplied by a labor rate. Downtime is indicated as being required, but the value is set to 0. Energy costs use a historical energy cost or fixed rate historical consumption, depending on the data available, and is indicated as not being required in this example.

Exemplary parameters and their requirements are shown in the table below:

| Parameter | Behavior |
|---|---|
| Labor Rate | Not Required. If no value is entered, the application |
| | calculates labor costs from history. (Costs are |
| | inflated to current year currency). If a value is |
| | entered, the application multiplies the labor hours * |
| | labor rate to calculate the cost. |
| Cost Per Downtime | Not Required. If no value is entered, the application |
| Hour | excludes downtime cost from the calculation |
| | (effectively Cost = 0). If a value is entered, the |
| | application multiplies downtime hours * cost per |
| | downtime hour to calculate the downtime cost. |
| Cost per Energy | Not Required. If no value is entered, the application |
| Unit | calculates energy costs from history. (Costs are |
| | inflated to current year currency). If a value is |
| | entered, the application multiplies the energy units * |
| | cost per energy unit to calculate the cost. To exclude |
| | Energy from the calculation, set value = 0 |
| Total Capitalized | Not Required. If no value is entered, the application |
| Cost | calculates total capitalized from history (Purchase |
| | Price + Prep Costs). (Costs are inflated to current |
| | year currency). If a value is entered, the application |
| | uses the entered to calculate depreciation costs |
| Depreciation Type | Determines which of the depreciation methods will |
| | be used to calculate depreciation costs. Straight- |
| | Line (Selected by, Default), Double-Declining, or |
| | Sum of Years |
| Salvage Percentage | Determines percentage of Capitalized Cost that will |
| | be retained when the asset is disposed. Used in |
| | depreciation calculation. Convert number to |
| | Percentage for calculation |
| Depreciation Term | Number of months to be used in the depreciation |
| (Months) | calculation |
| Discount Factor | Interest Rate used to value cost of capital and used |
| | in the equivalent annual cost calculation and to |
| | discount future costs. Convert number to percentage |
| | for calculation |
| Include Warranty | Yes, warranty costs are included in the maintenance |
| Costs | cost calculation (including labor cost as above) |
| | No, warranty costs are excluded |
| Maximum Years to | Maximum number of years to display on the results |
| Display | grids and charts. Note that this is a change from |
| | current functionality that converts the months to |
| | years. MEAC is an annualized calculation |
| Utilization Meter | Determines which meter type will be used to |
| | calculate utilization: Distance, Time, or Count. If |
| | the asset selected does not have one of these meters, |
| | no usage is included. |

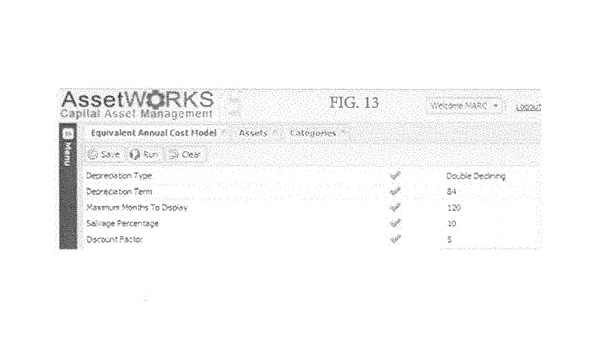

Once the factors are selected, depreciation parameters are set as well, as shown in FIG. 13. A number of depreciation methods may be available to the user, including but not limited to straight-line, double declining and sum-of-years depreciation. These are generally known in the art. The depreciation term is selected, exemplified as being in months followed by a maximum number of months to display (in the charted output) along with a salvage factor as a percent of the purchase price and a discount factor for evaluating the end-of-life value in a given time period.

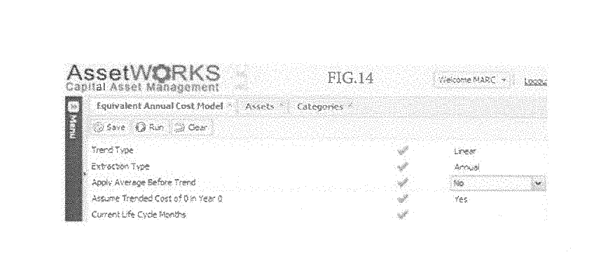

FIG. 14 shows the next step in preparing for the analysis, where a trend type is selected, such as from a predetermined list of none, best fit, linear, quadratic, cubic or quartic regression models. The data may also be averaged before applying the trend fit, and the analysis can begin at year 0 or some other user-selected period.

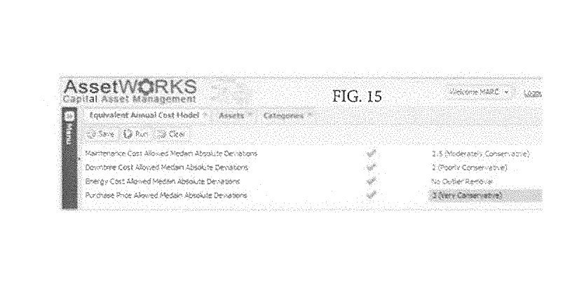

The user next selects the appropriate response to data outliers, although the invention applied the median absolute deviation method as was described above. The user is able to select a sensitivity to outliers. In the preferred embodiment, the sensitivity is selected scale from 0-3, where 0 is no sensitivity to outliers. At the other end of the spectrum, the model can be set to exclude a large number of potential outlier. This interface is exemplified in FIG. 15. Users can also see the number of values removed for each period on the results tab, and adjust the sensitivity in real-time if too many or too values seem to be removed.

Now that the model parameters have been set, and the appropriate way of managing data outliers has been selected, the user is able to execute and run the model. It will be appreciated that compared to prior art methods and systems, the user's ability to select parameters and adjust the way outliers are handled is significantly improved over the prior art, where such parameters are programmed into each instance of executing the model.

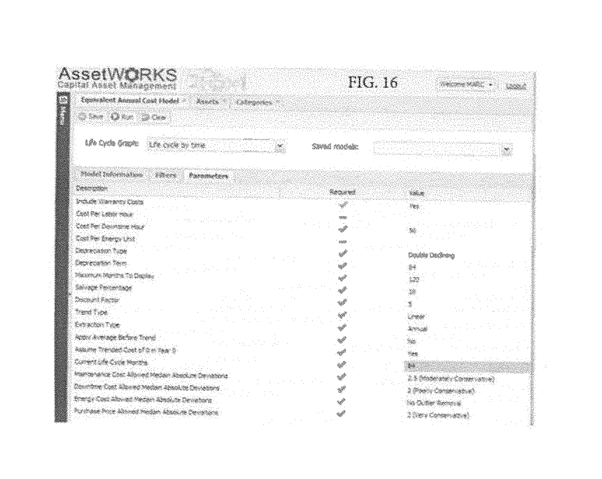

Executing the model is exemplified in FIG. 16, where an input is required for all required parameters (or must be available from the data set), and a user runs the model. Parameters may be saved for future instances, for example if the dataset is updated, a user could simply load the parameter list and rerun the model. The model can also be run a number of times merely by changing parameters from the screen in FIG. 16, or by adjusting the values for each parameters.

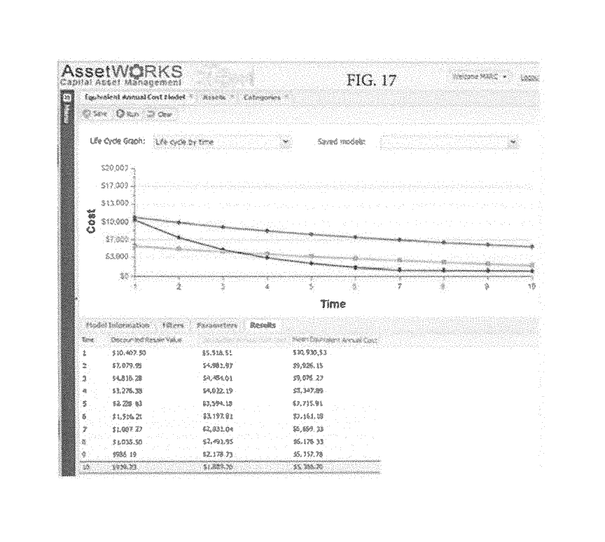

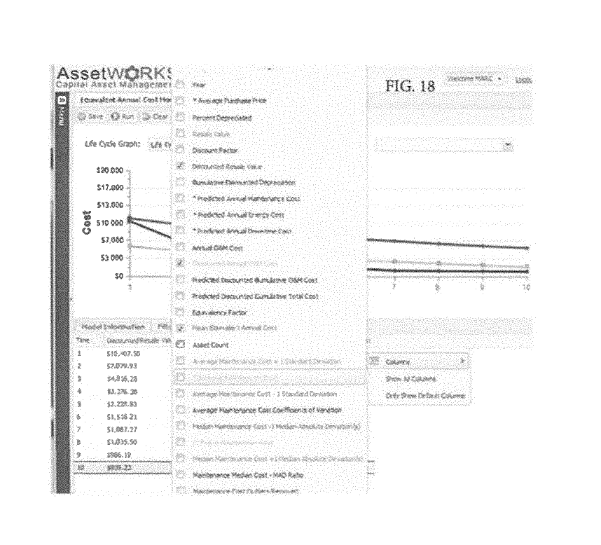

Finally, the system generates results in any of a number of ways, and enables the viewing of results in a number of different user-selected formats and visualizations. Some of these are exemplified in FIGS. 17-22. FIG. 17 shows the preferred default results view which includes discounted resale values of the assets, discounted O&M costs, and displays the mean equivalent annual cost model for an exemplary set of the data. FIG. 18 shows the user-selected manner of displaying results where additional columns can be added to the results gird, colored measures can be displayed on the graphs and a number of other ways of displaying or evaluating the results can be selected. It should be noted that if there is a change in the data set, the user merely has to rerun the model, without adjusting the model itself or re-importing and assessing the quality of the data. In addition, the user may modify parameters to nearly instantly see the change in outcome this would produce. When compared with the prior art hardware and software arrangement of performing this type of analysis, the prior art would require hours, if not days, to execute each change in model parameters of changes in the dataset, and even then, the user would not have a high degree of confidence in the data set itself. For example, the prior art lacks the ability to handle outlier data or adjust parameters on the fly.

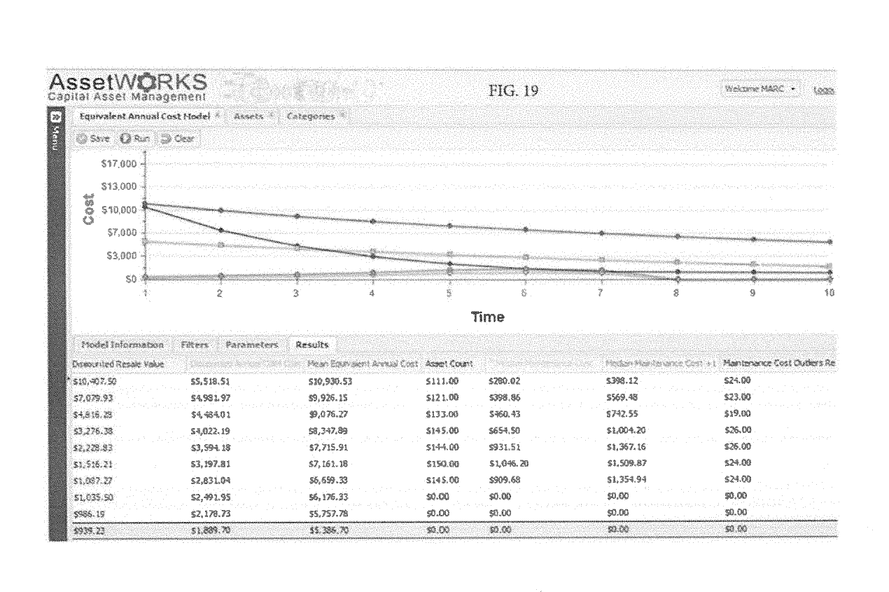

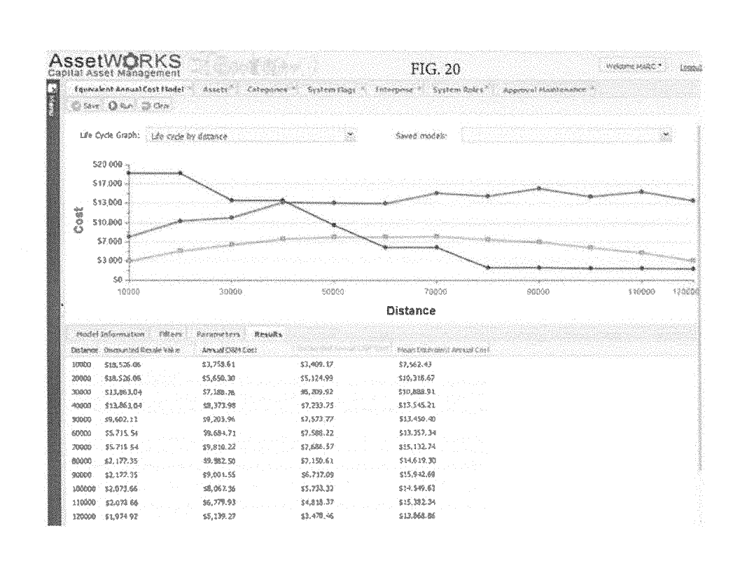

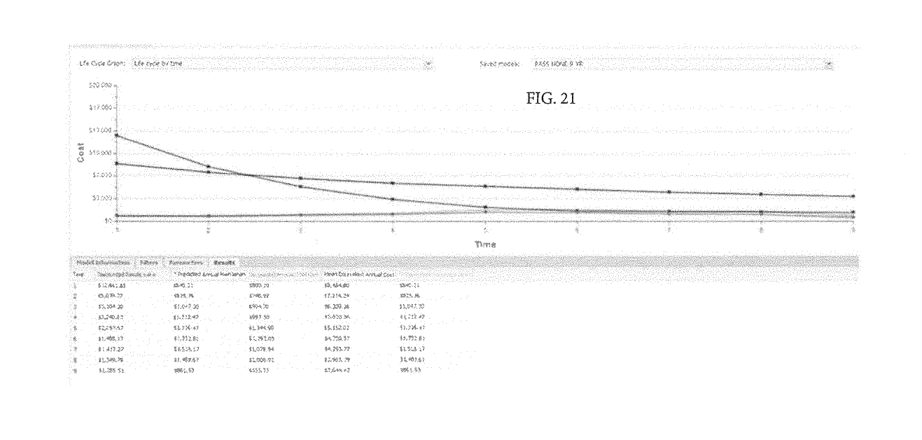

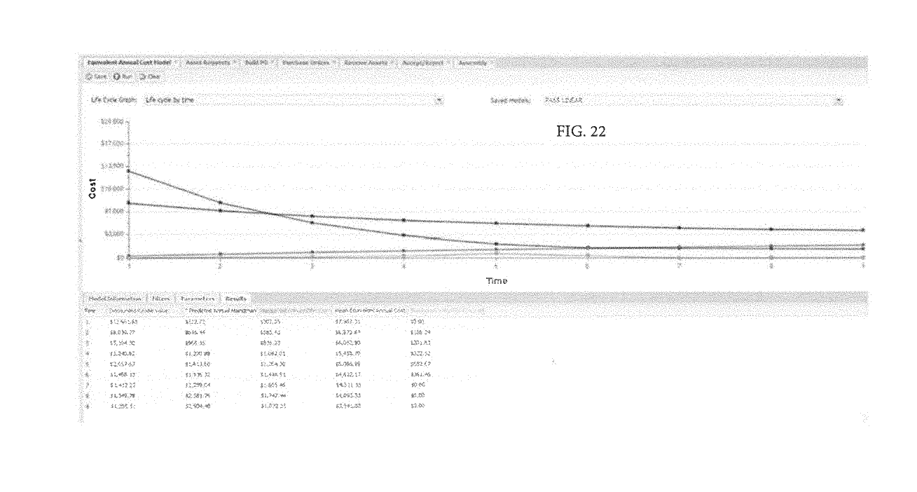

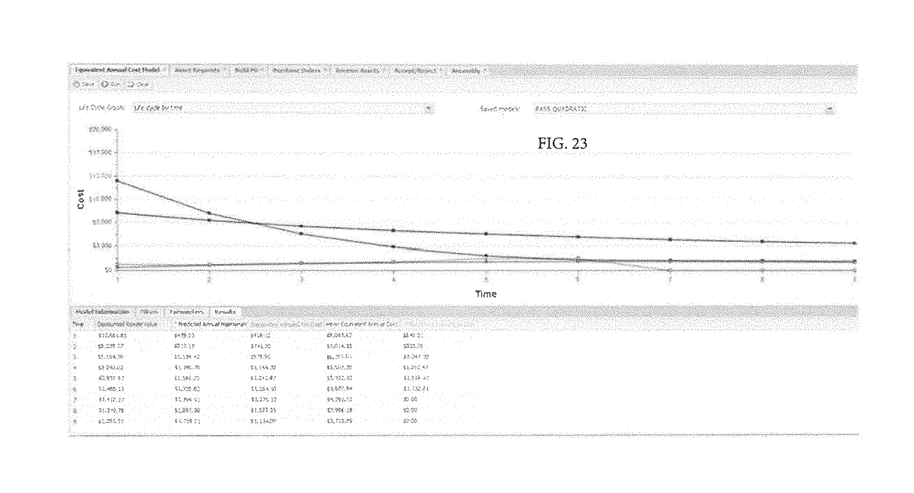

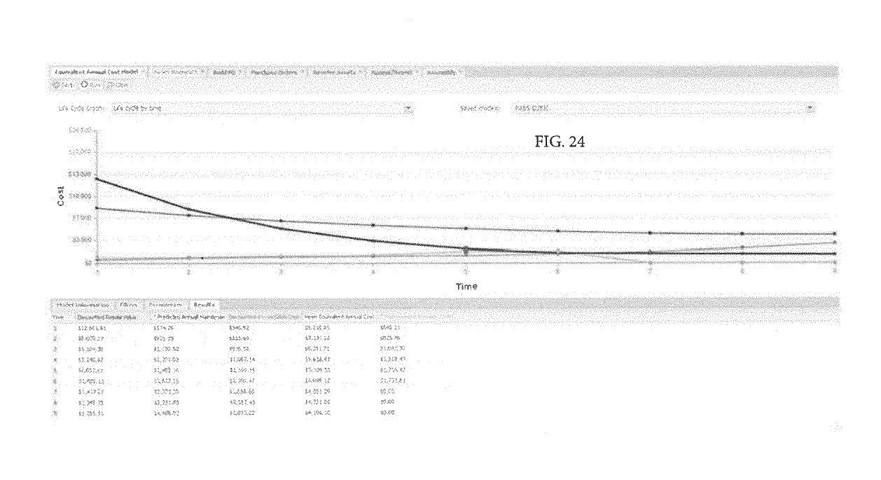

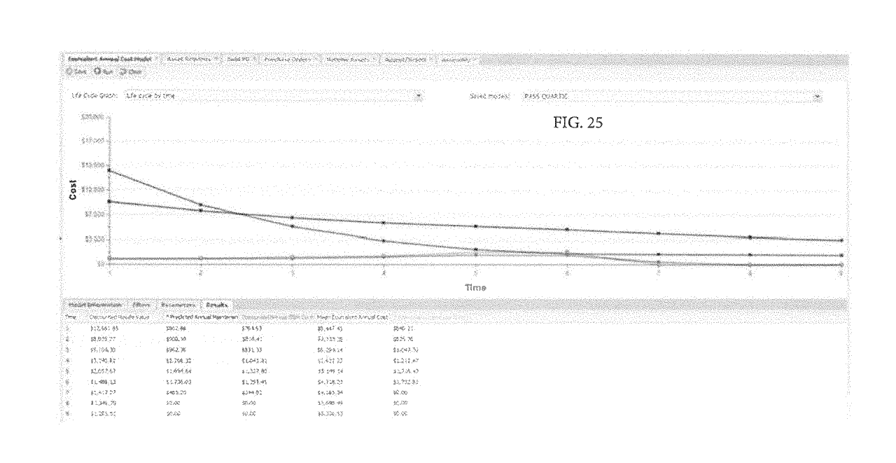

FIG. 19 shows the change in presented results with the addition of additional cost factors being incorporated into the model. FIG. 20 shows a different analysis presented as cost per distance, rather than cost per time. FIG. 21 shows exemplary results having no trending curve fit to the data with maintenance costs based on the actual life-span average costs. FIG. 22 shows the data of FIG. 21 having a linear trending cost applied, rather than actual maintenance costs. FIG. 23 shows a second degree polynomial quadratic trend applied. FIG. 24 shows a cubic trend, and FIG. 25 a quartic trend forecasting maintenance data.

Finally, the CAMAS uses the generated data to determine the optimal replacement year of each of the assets. The final calculation may be based on the mean equivalent annual cost and an estimate of what the average cumulative utilization is in the year with the lowest equivalent annual cost (as described above in the model description). The results of this calculation are:
Lowest MEAC: The lowest annual mean equivalent annual cost of any year. If the cost curve has a linear negative slope, the lowest year will be the maximum year displayed.
MEAC Year: the year with the lowest annual mean equivalent annual cost
Cumulative Usage in MEAC Year: The cumulative annual use in the year with the lowest MEAC

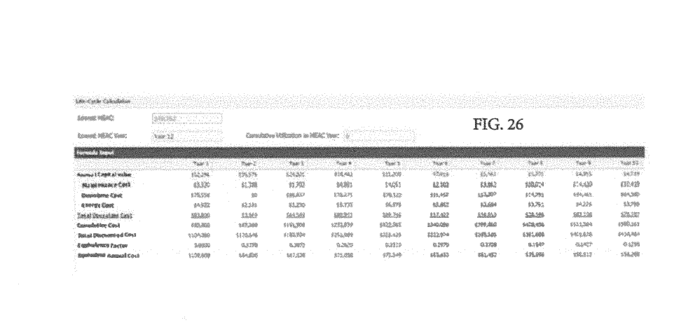

The data grid presented to the user shows the cost trends in the life-cycle calculation, and preferably includes the following data, with an exemplary life cycle calculator output show in FIG. 26, from where the lowest MEAC year can be selected as the year to replace an asset.
Annual Capital Value: Displays the discounted net book value at year's end after the depreciation expense for the year has been deducted from the book value at the start of the year. If the salvage percentage is set to 0, the depreciation expense in the final year of the depreciation term is 0, otherwise the final year cost should equal total capitalized cost*salvage percentage. The Discount Factor is applied to convert future costs to current year costs.
Maintenance: Discounted trended maintenance costs
Downtime: Discounted trended downtime costs
Energy: Discounted trended energy costs
Total Operating Costs: Discounted sum of Maintenance, Downtime and Energy
Cumulative Operating Costs: Sum of operating cost for the year and all prior years
Total Discounted Costs: Sum of Net Book Value and Cumulative Operating Costs for each year
Equivalency Factor: The factor used to generate the equivalent annual cost, based on the period (r) and discount rate parameter (i) [i(1+i)R/(1+i)R−1]
Equivalent Annual Cost: The total discounted costs*the equivalency factor

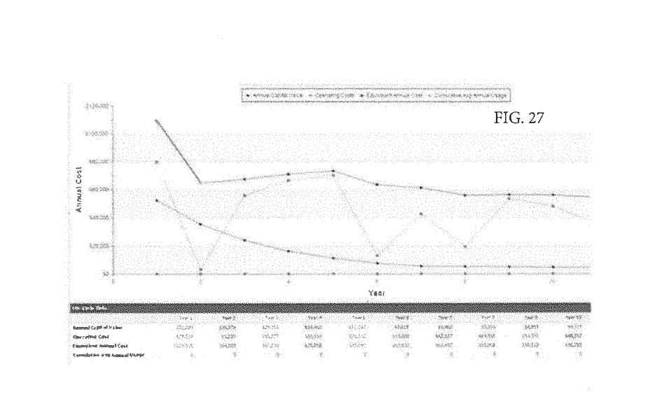

A life-cycle graph for each of the assets may also be generated, and could have four basic components: Discounted Resale Value, Discounted Cumulative Operating Cost, and Equivalent Annual Costs, and the Cumulative Annual Usage. Such a graph is illustrated in FIG. 27.

It will be clear to one skilled in the art from the foregoing that with the volume of data that requires analysis, the particular hardware configuration including the arrangement and interaction of the different servers and software configured to instruct the hardware in a novel manner provides an improvement over the prior art. Indeed, even if one were to provide improvements in computing power to the prior art approach as was shown in FIG. 1, the results would not match those provided by the present invention, in which changes to the data set, parameters input into the model and manner in which the results are viewed can be adapted by a user in close to real-time. The changes to the data set and method for handling data outliers is altogether absent from the known prior art. In addition, the ability to adjust how data outliers are handled and to instantly view the results of the model applied to the dataset depending on how outliers are handled permits a user a degree of data visualization and customization that is not present in the prior art.

It will be apparent to one of skill in the art that other configurations, hardware etc may be used in any of the foregoing embodiments of the products, methods, and systems of this invention. It will be understood that the specification is illustrative of the present invention and that other embodiments within the spirit and scope of the invention will suggest themselves to those skilled in the art. All references cited herein are incorporated by reference.

What is claimed is:

1. A system for physical asset resource planning comprising:
a capital asset management (CAM) application server in data communication with a CAM report server and a CAM database server; each of the servers including a computer processor and a computer readable medium having instructions thereon executable by the computer processor;
said CAM application server configured to:
execute a life cycle module for generating an asset life cycle model based on user inputs customizing the model for each instance of its execution; and;
execute a life cycle calculator for generating an annual cost for an asset based on the life cycle model and on a dataset received from the CAM database server;
said CAM report server configured to:
execute a presentation module for displaying results of the life cycle module and the life cycle calculator to a user;
a CAM database server configured to:
store a plurality of datasets related to a plurality of assets; and
provide data to the CAM application server for executing the life cycle calculator and to provide data to the CAM report server.

2. The system according to claim 1, wherein the CAM application server and the CAM report server communicate to implement a presentation layer in a model-view-controller arrangement, wherein the model component manages data, logic and rules of a CAM application, the view component provides an output representation of information and the controller component accepts inputs from a user and converts the inputs to commands for the model or view components.

3. The system according to claim 1, further comprising a fleet management system in data communication with the CAM database to provide the plurality of stored datasets.

4. The system according to claim 3, wherein the fleet management system includes a telematics interface, a maintenance interface and a source data database for temporarily storing data received from the telematics interface and from the maintenance interface; and wherein the telematics interface receives data from one or more sensors located on each asset and the maintenance interface receives data from a maintenance shop computer performing maintenance on each asset.

5. The system according to claim 2, wherein the CAM application server provides a service layer including an interface for exchanging data with the presentation layer, a business logic model and an object relational mapping module.

6. The system according to claim 5, wherein the business logic module defines fixed parameters and rules of the CAM application.

7. The system according to claim 5, wherein the object relational mapping module defines the relationship between different data sets and objects to which the business logic module is applied.

8. The system according to claim 1, wherein the life cycle module applies a mean annual cost equivalent life-cycle model to determine an optimal time to replace one or more assets.

9. The system according to claim 8, wherein the mean annual cost equivalent is determined from
$$( {MACE}_{R} ) = [ P - \frac{{S}_{R}}{{( 1 + i )}^{R}} + {\sum }_{t = 1}^{R} \frac{{X}_{t}}{{( 1 + i )}^{t}} ] [ \frac{{i ( 1 + i )}^{R}}{{( 1 + i )}^{R} - 1} ]$$
where: i=discount rate
P=purchase price at
t=year (numeral indicator)
S=resale or salvage value
R=year of replacement
X=sum of the year's costs (excluding depreciation, alternative cost of capital and inflation)

10. The system according to claim 9, where the CAM application server enables users to generate custom life-cycle models based on user-defined parameters modifying the mean annual equivalent cost model.

11. The system according to claim 10, wherein the user defined parameters include one or more of Labor Rate, Cost Per Downtime Hour, Cost per Energy Unit, Total Capitalized Cost, Depreciation Type, Salvage Percentage, Depreciation, Discount Factor, Include Warranty Costs, Maximum Years to Display and Utilization Meter.

12. The system according to claim 11, wherein the CAM application server, via the life cycle module, is configured to remove data outliers from the data received from the CAM database server.

13. The system according to claim 12, wherein data outliers are removed based on a sensitivity level determined by a user.

14. The system according to 11, wherein the life cycle calculator accepts as a user-input a filter of categories of assets to be included in the analysis.

15. The system according to claim 11, wherein the user selects a depreciation method for applying depreciation to the analysis.

16. The system according to claim 15, wherein the CAM report server is configured to enable the viewing of annual costs for each asset based on the life cycle model.

17. The system according to claim 16, wherein the CAM report server accepts user inputs via the presentation layer to display reports and visualizations based on user-selected formats.

18. The system according to claim 17, wherein the CAM application server uses the generated data to determine an optimal replacement year for each of the assets.
